(19) United States
(12) Patent Application Publication
(10) Pub. No.: US 2009/0184079 A1
(43) Pub. Date: Jul. 23, 2009

(54) Heavy duty hoist

(76) Inventor: Scott Mackiwicz, Harwinton, CT (US)

Correspondence Address: TED PAULDING, 10 PENWOOD LA., WETHERSFIELD, CT, 06109, US

(21) Appl. No.: 12/006,574

(22) Filed: Jan. 3, 2008

(51) Int. Cl. B66C 3/06; E04G 21/16

(52) U.S. Cl. 212/243; 414/11

(57) ABSTRACT

A heavy duty hoist for use in lifting and transporting stacked concrete forms and the like has a main body with a vertically extending guideway which receives an operating slide. Rigid arms extend in opposite directions at the bottom of the body with pivot pins at their outer ends. A second pair of arms extend from the slide to the pivot pins and carry sleeves engageable with the pins for pivotal movement with vertical movement by the slide. Rigid outer sections of the second pair of arms depend from the inner sections and carry inwardly projecting lifting elements at their lower end portions for engagement beneath a stack of forms. The slide carries a pair of rollers above and below the inner end portion of each of the free end portions of the second pair of arms with slight longitudinal relative movement thus accommodated. A lifting device in the form of a simple eye-member is mounted on the slide.

### BACKGROUND OF THE INVENTION

Heavy concrete forms, for example the type used in pouring cellar walls in residential construction, are difficult to handle manually and there is little or nothing available in the way of power operated lifting equipment for stacks of such forms.

Accordingly, it is the general object of the present invention to provide a heavy duty hoist for stacks of forms which can be easily lifted by on-site equipment such as a backhoe equipped with a simple chain and lifting hook, the hoist being of desirably simple construction and yet highly efficient in operation over a long and durable life span.

### SUMMARY OF THE INVENTION

In fulfillment of the foregoing object and in accordance with the present invention, a heavy duty hoist for stacks of forms is provided with a main body adapted to be disposed centrally above a vertical stack of forms. The body has a vertically extending guideway which receives a slide movable in one and an opposite direction in the guideway and which carries a releaseably engageable lifting and lowering device at its upper end. The lifting and lowering device preferably takes the form of a simple eye member which can be engaged by a hook member at the end of a chain on a backhoe.

The slide is also provided with stop means limiting travel of the slide in at least one direction of movement. Preferably, the stop means limits movement of the slide in both directions and upward movement of the slide in the lifting direction is limited by one stop after a first increment of movement which causes the hoist to engage a lowermost form with upward slide movement thereafter raising the hoist bodily and thus lifting the stack of forms.

A first pair of arms extend respectively in opposite substantially horizontal directions from the body and each has its inner end fixedly secured to the body and carries a pivot member at its free outer end portion. A second pair of arms has inner sections extending respectively in substantially horizontal opposite directions from the slide and outer sections fixedly attached to and depending from the outer and free end portions or the inner sections. Interconnecting portions between inner and outer sections carry pivot members co-operative with the pivot members on the first pair of arms. Lower and free end portions of the depending portions of the second pair of arms have inwardly projecting lifting elements adapted to enter and retract from opposite directions beneath the lowermost form in a stack of forms. Thus, the stack of forms may be selectively raised and lowered, the inner portions of the inner sections of the second pair of arms being connected with the slide for vertical movement therewith and for limited longitudinal movement of the inner arm sections relative to the slide thus permitting limited pivotal movement of the second pair of arms and the entry and retraction of the lifting elements beneath the stack of forms.

### DESCRIPTION OF THE DRAWINGS

FIG. 1 of the drawings shows a stack of concrete forms with the hoist of the present invention in operative position adjacent the forms but in an open attitude,

FIG. 2 shows the stack of forms with the hoist in a closed attitude about the forms ready for a lifting operation,

FIG. 3 is an enlarged front view showing details of the body, slide and inner portions of the arms of the hoist,

FIG. 4 is an enlarged front view showing the outer portions of the hoist,

FIG. 5. Is an enlarged side view of the slide, and

FIG. 6 is an enlarged top view of the body including the slide.

### DESCRIPTION OF A PREFERRED EMBODIMENT

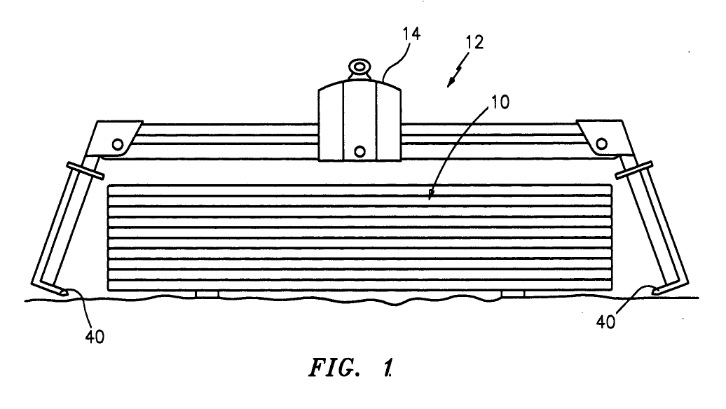

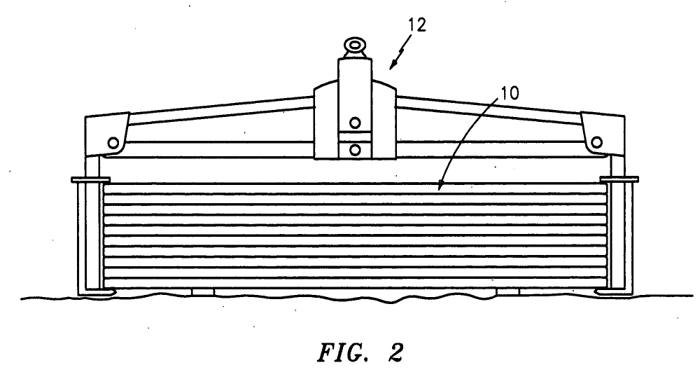

Referring initially to FIGS. 1 and 2, a stack of forms is indicated generally at 10 with the hoist in operative but open position adjacent thereto and indicated generally at 12 in FIG. 1.

In FIG. 2, the hoist 12 is in a closed position in engagement with the stack of forms 10, and about to lift the same.

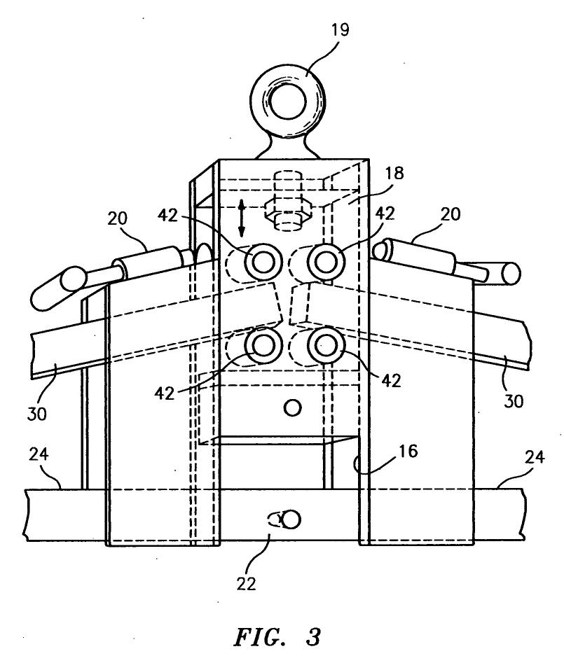

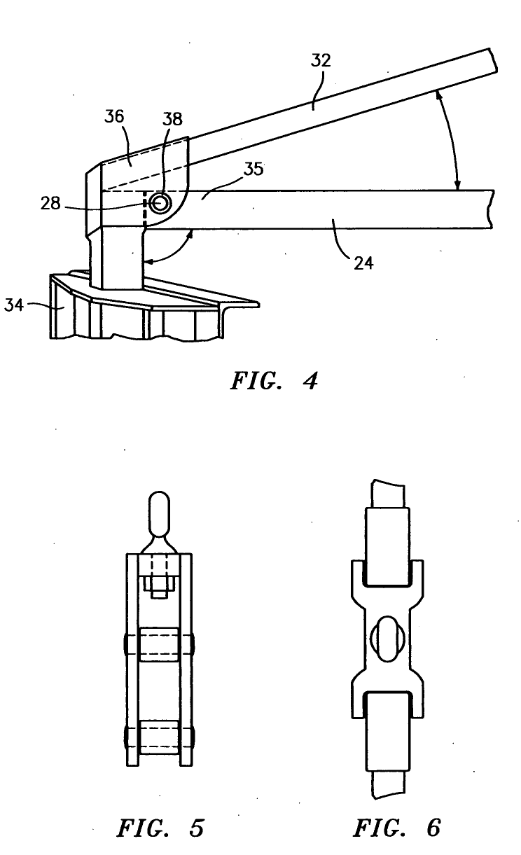

The hoist of the invention comprises the main body 14 which has a vertically extending guideway best illustrated in FIGS. 3 and 4. The slide 18 is moveable vertically in the guideway 16 between upper and lower positions, and is shown at its upper position in FIG. 3 with its travel limited by stop pins 20, 20. This is the position at which the slide operates to close the hoist as shown in FIG. 2 and as will be described herein below. In its lowermost position, the slide is limited in its travel by engagement with an intermediate section 22 of a first pair of arms 24, 24. This stop means limits opening movement of the hoist as shown in FIG. 2. A releasably engageable lifting and lowering device, preferably in the form of a simple eye-member 19, and may be engaged by a simple hook on a backhoe or the like.

The arms 24, 24 extend respectively in opposite substantially horizontal directions from the main body with their inner end portions fixedly attached to the body. Free outer end portions 26, 26 carry pivot members 28, 28 as best illustrated in FIG. 4, preferably in the form of pivot pins.

A second pair of arms 30, 30 have inner sections 32, 32 which extend respectively in opposite substantially horizontal directions from the slide 18. Outer sections 34 of the arms FIGS. 1, 2, and 4, depend from the free end portions of the inner sections 32, 32. Interconnecting portions of each arm in the form of gussets 36, 36 carry pivot members 38, 38 respectively co-operative with the pivot pins 28, 28 on the first pair of arms. Lower and free end portions of the depending portions of the second pair of arms carry inwardly projecting lifting elements 40, 40, adapted to enter and retract in opposite directions beneath the lowermost form in a stack of forms, the stack thus being selectively raised and lowered by the hoist.

The inner and free end portions of the inner sections of the second pair of arms 30, 30 are connected with the slide 18 for arcuate substantial vertical movement therewith and for limited longitudinal movement relative thereto.

This arrangement accommodates limited pivotal movement of the second pair of arms and the entry and retraction the lifting elements 40,40 beneath the stack of forms. As best illustrated in FIG. 3 at least one pair of rollers 42, 42 is provided for engagement with the inner ends of the arms 30, 30 during the lifting mode of the slide. The lowermost rollers 42, 42 fulfill this function. Both upper and lower rollers however are presently preferred with the upper rollers 42, 42 positively urging the inner ends of the arms 30, 30 in a downward direction thus opening the hoist. As will be apparent the inner ends of the arms 30, 30 are free to move longitudinally relative to all four rollers 42, 42.

As will be apparent from the foregoing, a heavy duty hoist has been provided and is simple in construction, subject to manufacture at economic advantage, and highly efficient in a long and durable service life.

1. A heavy duty hoist for use in lifting and transporting stacked concrete forms and the like; said hoist comprising a main body adapted to be disposed centrally above a vertical stack of forms and having a vertically extending guideway, a releaseably engageable lifting and lowering device, a slide mounting said lifting and lowering device and movable vertically in one and an opposite direction in said guideway, stop means limiting travel of said slide in at least one direction in said guideway, a fist pair of arms extending respectively in opposite substantially horizontal directions from said body and each having an inner end portion fixedly attached to said body and a free outer end portion carrying a pivot member, a second pair of arms having inner sections extending respectively in opposite substantially horizontal directions from said slide and outer sections fixedly attached to and depending from the free end portions of the inner sections, interconnecting portions of each arm between inner and outer sections carrying pivot members respectively co-operative with the pivot members on said first pair of arms, lower and free end portions of said depending portions of said second pair of arms having inwardly projecting lifting elements adapted respectively to enter and retract from opposite directions beneath the lowermost form in a stack of forms and thus selectively raise and lower the stack of forms, and the inner and free end portions of the inner sections of said second pair of arms being connected with said slide for vertical movement therewith and for limited longitudinal movement of the inner arm sections relative to the slide permitting limited pivotal movement of the second pair of arms and entry and retraction of the lifting elements beneath the stack of forms.

2. A heavy duty hoist as set forth in claim 1 wherein at least one free roller is provided in the slide on at least one side of the inner end portion of the inner section of each of the second pair of arms.

3. A heavy duty hoist as set forth in claim 2 wherein the roller is operative when the hoist is in a loaded mode with the weight of the stack of forms carried thereby.

4. A heavy duty hoist as set forth in claim 3 wherein free rollers are provided on both sides of the inner end portion of the inner section of each second arm.

5. A heavy duty hoist as set forth in claim 1 wherein the stop means limits the travel of the slide so that a first increment of movement of the lifting and lowering device operates the opening and closing of the hoist and movement thereafter raises the body of the hoist and the stack of forms.

6. A heavy duty hoist as set forth in claim 1 wherein gussets are provided at the interconnecting portions of the second arms.

7. A heavy duty hoist as set forth in claim 1 wherein stop means are provided in both directions of slide movement and wherein one of said stop means is removable.
